(19) United States
(12) Patent Application Publication
(10) Pub. No.: US 2018/0274935 A1
(43) Pub. Date: Sep. 27, 2018

(54) TRAVELING MANAGEMENT APPARATUS, AUTONOMOUS TRAVELING APPARATUS, TRAVELING MANAGEMENT METHOD, AND TRAVELING MANAGEMENT PROGRAM

(71) Applicant: SHARP KABUSHIKI KAISHA, Sakai City (JP)

(72) Inventor: HIROKI SUGIYAMA, Sakai City (JP)

(21) Appl. No.: 15/934,481

(22) Filed: Mar. 23, 2018

(30) Foreign Application Priority Data
Mar. 24, 2017 (JP) 2017-059587

(51) Int. Cl. G01C 21/34; G05D 1/02; B60W 30/16

(52) U.S. Cl. CPC G01C 21/3415; G05D 2201/0207; B60W 30/16; G05D 1/0293

(57) ABSTRACT

A server that manages traveling of a plurality of traveling apparatuses which carry out monitoring circulation by autonomous traveling includes a communication unit that communicates with the traveling apparatuses, a departure determination unit that determines whether a departure from the monitoring circulation is to be made or not, a traveling speed changing unit that changes traveling conditions for monitoring traveling of the other traveling apparatuses so that a monitoring region of the traveling apparatus which is to depart from the monitoring circulation is complemented, and a traveling management unit that manages the traveling of the traveling apparatuses and the changed traveling conditions are transmitted to the respective traveling apparatuses.

### BACKGROUND

### 1. Field

The present disclosure relates to an autonomous traveling apparatus that travels along a circulation path, a traveling management apparatus, a traveling management method, and a traveling management program.

### 2. Description of the Related Art

In recent years, autonomous traveling apparatuses that are capable of autonomously traveling have been developed. The autonomous traveling apparatuses travel while autonomously determining migration paths, speeds, and contents of work in accordance with programs and learned information.

A related art in which a plurality of autonomous traveling apparatuses travel for monitoring circulation and in which, in case where one of the autonomous traveling apparatuses departs from a monitoring circulation path for some cause, monitoring is continued with the monitoring circulation path of the departing autonomous traveling apparatus taken over by (one or a plurality of) other autonomous traveling apparatuses has been proposed (see Japanese Unexamined Patent Application Publication No. 2008-160496), for instance.

Such autonomous traveling apparatuses as disclosed in Japanese Unexamined Patent Application Publication No. 2008-160496, however, cause a problem in that the takeover of only the monitoring path by other autonomous traveling apparatuses may cause mere extension in a monitoring path of each of the other autonomous traveling apparatuses, laxer monitoring status as an entire monitoring system, and an insufficient monitoring function.

In consideration of the above problem, it is desirable to provide a traveling management apparatus, an autonomous traveling apparatus, a traveling management method, and a traveling management program by which a monitoring function as an entire monitoring circulation system in monitoring circulation traveling by a plurality of autonomous traveling apparatuses may be continuously managed without being impaired even in case where an autonomous traveling apparatus that is traveling departs from a traveling path for some cause.

### SUMMARY

A traveling management apparatus, an autonomous traveling apparatus, a traveling management method, and a traveling management program according to the disclosure for settling the problem described above are as follows.

In the disclosure, a traveling management apparatus for autonomous traveling apparatuses exercises traveling management of a plurality of autonomous traveling apparatuses which autonomously travel based on preset path information, the traveling management based on traveling information indicating traveling status as notification from the autonomous traveling apparatuses. The traveling management apparatus includes: a communication unit that communicates with the autonomous traveling apparatuses; a departure determination unit that determines whether a departure from monitoring circulation along a preset traveling path is to be made or not based on the traveling information on a relevant autonomous traveling apparatus; a traveling condition changing unit that, when the departure determination unit determines that the relevant autonomous traveling apparatus is to depart from the monitoring circulation, changes traveling conditions for monitoring traveling of the other autonomous traveling apparatuses so that a monitoring region based on the path information on the autonomous traveling apparatus which is to depart from the monitoring circulation is complemented; and a traveling management unit that manages traveling of the autonomous traveling apparatuses. The traveling management unit transmits the changed traveling conditions from the communication unit to the respective autonomous traveling apparatuses.

In the disclosure, an autonomous traveling apparatus has a traveling management apparatus that exercises traveling management of a plurality of autonomous traveling apparatuses which autonomously travel based on preset path information, the traveling management based on traveling information indicating traveling status as notification from the autonomous traveling apparatuses. The traveling management apparatus includes: a communication unit that communicates with the autonomous traveling apparatuses; a departure determination unit that determines whether a departure from monitoring circulation along a preset traveling path is to be made or not based on the traveling information on a relevant autonomous traveling apparatus; a traveling condition changing unit that, when the departure determination unit determines that the relevant autonomous traveling apparatus is to depart from the monitoring circulation, changes traveling conditions for monitoring traveling of the other autonomous traveling apparatuses so that a monitoring region based on the path information on the autonomous traveling apparatus which is to depart from the monitoring circulation is complemented; and a traveling management unit that manages traveling of the autonomous traveling apparatuses. The traveling management unit transmits the changed traveling conditions from the communication unit to the respective autonomous traveling apparatuses.

In the disclosure, a traveling management method for autonomous traveling apparatuses of exercising traveling management of a plurality of autonomous traveling apparatuses which autonomously travel based on preset path information, the traveling management based on traveling information indicating traveling status as notification from the autonomous traveling apparatuses, includes: communicating with the autonomous traveling apparatuses; determining whether a departure from monitoring circulation along a preset traveling path is to be made or not based on the traveling information on a relevant autonomous traveling apparatus; changing traveling conditions for monitoring traveling of the other autonomous traveling apparatuses, when it is determined in the determining that the relevant autonomous traveling apparatus is to depart from the monitoring circulation, so that a monitoring region based on the path information on the autonomous traveling apparatus which is to depart from the monitoring circulation is complemented; and managing traveling of the autonomous traveling apparatuses. The managing includes transmitting the changed traveling conditions through the communicating to the respective autonomous traveling apparatuses.

In the disclosure, a traveling management program for autonomous traveling apparatuses that exercises traveling management of a plurality of autonomous traveling apparatuses which autonomously travel based on preset path information, the traveling management based on traveling information indicating traveling status as notification from the autonomous traveling apparatuses, makes a computer execute a process including: communicating with the autonomous traveling apparatuses; determining whether a departure from monitoring circulation along a preset traveling path is to be made or not based on the traveling information on a relevant autonomous traveling apparatus; changing traveling conditions for monitoring traveling of the other autonomous traveling apparatuses, when it is determined in the determining that the relevant autonomous traveling apparatus is to depart from the monitoring circulation, so that a monitoring region based on the path information on the autonomous traveling apparatus which is to depart from the monitoring circulation is complemented; managing traveling of the autonomous traveling apparatuses; and transmitting the changed traveling conditions through the communicating to the respective autonomous traveling apparatuses in the managing.

### BRIEF DESCRIPTION OF THE DRAWINGS

FIG. 1 is a schematic diagram illustrating an autonomous traveling apparatus management system according to a first embodiment;

FIG. 2 is a block diagram illustrating a traveling apparatus;

FIG. 3 is a block diagram illustrating a server;

FIG. 4 is a sequence diagram illustrating processing for circulation traveling in the traveling apparatus and the server;

FIG. 5 is a sequence diagram illustrating processing for changing monitoring circulation traveling conditions in the traveling apparatuses and the server in the first embodiment;

FIG. 6 is a sequence diagram following FIG. 5 and illustrating the processing for changing the monitoring circulation traveling conditions in the traveling apparatuses and the server;

FIG. 7A is an explanatory drawing illustrating an example of equal allocation of inter-vehicle distances between a plurality of traveling apparatuses that carry out monitoring circulation in the first embodiment;

FIG. 7B is an explanatory drawing illustrating an example of equal allocation of inter-vehicle distances in case of a departure of one from the plurality of traveling apparatuses that carry out the monitoring circulation;

FIG. 8A is an explanatory drawing illustrating an example of equal allocation of inter-vehicle distances between a plurality of traveling apparatuses that carry out monitoring circulation in a second embodiment;

FIG. 8B is an explanatory drawing illustrating an example of monitoring traveling in which the monitoring circulation is carried out with changes in monitoring imaging regions in case of a departure of one from the plurality of traveling apparatuses that carry out the monitoring circulation;

FIG. 9A is an explanatory drawing illustrating an example of equal allocation of inter-vehicle distances between a plurality of traveling apparatuses that carry out monitoring circulation in a third embodiment;

FIG. 9B is an explanatory drawing illustrating an example of monitoring traveling in which the monitoring circulation is carried out in accordance with brightness on a traveling path in case of departures of two from the plurality of traveling apparatuses that carry out the monitoring circulation;

FIG. 10A is an explanatory drawing illustrating an example of equal allocation of inter-vehicle distances between a plurality of traveling apparatuses that carry out monitoring circulation in a fourth embodiment;

FIG. 10B is an explanatory drawing illustrating an example of a change to fixed point observation in the traveling apparatuses;

FIG. 11A is an explanatory drawing illustrating an example of equal allocation of inter-vehicle distances between a plurality of traveling apparatuses that carry out monitoring circulation in a fifth embodiment; and

FIG. 11B is an explanatory drawing illustrating an example of monitoring traveling with reciprocation traveling of the traveling apparatuses.

### DESCRIPTION OF THE EMBODIMENTS

### First Embodiment

Hereinbelow, embodiments of a traveling management apparatus for autonomous traveling apparatuses of the disclosure will be described with reference to the drawings.

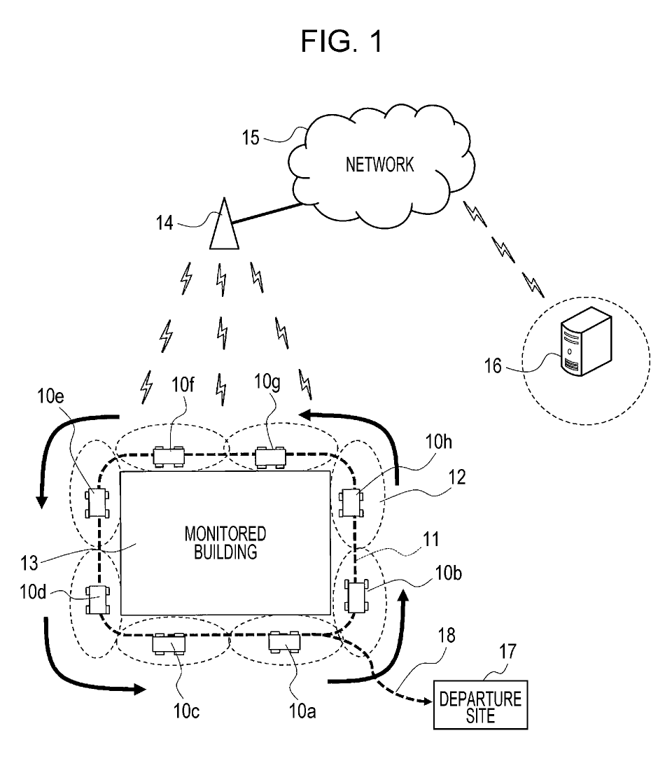

FIG. 1 is a schematic diagram illustrating an autonomous traveling apparatus management system according to a first embodiment.

As illustrated in FIG. 1, the autonomous traveling apparatus management system includes autonomous traveling apparatuses (hereinafter, referred to as traveling apparatuses) 10 (10a, 10b, 10c, 10d, 10e, 10f, 10g, and 10h), an access point 14, a network 15, and a server (such as a management server) 16 that functions as the traveling management apparatus. Though FIG. 1 illustrates a case in which the eight traveling apparatuses 10 monitor vicinities of a monitored building 13, the case is an example and any number of the traveling apparatuses may be used.

The traveling apparatuses 10 are each capable of carrying out wireless communication with the access point 14 via Wi-Fi, Bluetooth®, or the like. The access point 14 is connected via the network 15 to the server 16. This wireless communication scheme is an infrastructure mode that enables communication via the access point 14 among the traveling apparatuses 10 or with the server 16. An ad hoc mode may be used in which the traveling apparatuses 10 directly communicate with one another without using the access point 14.

The traveling apparatuses 10 circulate along an identical monitoring circulation path 11.

The server 16 exercises management while acquiring information on traveling status from each of the traveling apparatuses 10 via the network 15 and exercises navigated control for each of the traveling apparatuses 10. In case where a battery charge in a traveling apparatus 10 falls to or below a reference value or in case where a failure in a traveling function or a communication function of a traveling apparatus 10 makes it difficult for the traveling apparatus 10 to continue circulation traveling, the server 16 issues an instruction to move from the monitoring circulation path 11 to a departure site 17 where a charging station or the like is provided. A departure path 18 is set as a path for such a departure, for instance. Though there is one departure site in FIG. 1, a plurality of departure sites may exist. As a configuration other than the instruction from the server 16 to move to the departure site 17, a location of the departure site 17 may be stored in advance in each of the traveling apparatuses 10 so that the traveling apparatus 10 may go to the departure site 17.

The traveling apparatuses 10 are each equipped with a camera for attainment of monitoring and imaging functions so that a video (image) imaged with monitoring is temporarily stored in a storage unit with which the traveling apparatus 10 is equipped and the video (image) is then transmitted in real time via the access point 14 to the server 16. The server 16 analyzes the video (image) transmitted from each traveling apparatus 10 and may thereby detect an abnormality in a vicinity of each traveling apparatus 10 in real time. In FIG. 1, the server 16 controls the traveling of the traveling apparatuses 10 so that the traveling apparatuses 10 travel along the monitoring circulation path 11 with a given inter-vehicle distance ensured, based on an imageable region 12 around each traveling apparatus 10.

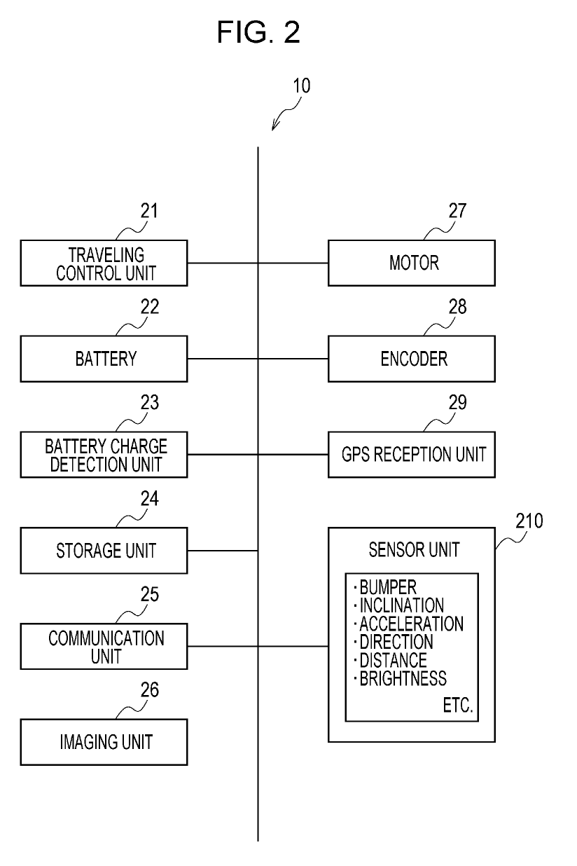

FIG. 2 is a block diagram illustrating the traveling apparatus 10 and functional blocks demanded for the circulation traveling.

As illustrated in FIG. 2, the traveling apparatus 10 includes a traveling control unit 21, a battery 22, a battery charge detection unit 23, a storage unit 24, a communication unit 25, an imaging unit 26, an electric motor (hereinafter, referred to as motor) 27, an encoder 28, a GPS reception unit 29, and a sensor unit 210.

The encoder 28 measures a speed of revolution based on pulses from the motor 27. The traveling control unit 21 calculates a traveling distance from the speed of revolution of the motor. The GPS reception unit 29 acquires position information on the traveling apparatus 10 by receiving radio waves from a GPS.

The sensor unit 210 is intended for detecting the traveling status of the traveling apparatus 10, obstacles, and the like and includes various sensors. The sensors may include a bumper, an inclination sensor, an acceleration sensor, a direction sensor, a distance sensor, a brightness sensor, or the like, for instance. The bumper is a sensor for detecting an external force that occurs in front and an impact sensor such as a vibration sensor and an acceleration sensor may be used for the bumper, for instance. The inclination sensor detects a tilt angle of the traveling apparatus 10. The direction sensor is a magnetic field sensor in which geomagnetism is used or the like, for instance, and detects a direction of the traveling. The distance sensor is a well-known sensor in which light, ultrasonic waves, or the like is used and measures a distance to an object. The brightness sensor measures brightness in the vicinity of the traveling apparatus 10 and the brightness is used for calculation on the imageable region in the imaging unit 26 that will be described later. With use of the sensors in combination of detection results from the encoder 28 or the GPS reception unit 29, a current traveling position, the traveling status, obstacles, or the like may be detected.

The battery charge detection unit 23 detects the battery charge.

The storage unit 24 is made of a memory such as a RAM and a ROM or a mass-storage device such as an HDD. Computer programs or various types of data is stored in the storage unit 24.

The communication unit 25 is intended for carrying out the communication among the traveling apparatuses 10 and the communication with the server 16 via the network 15.

The imaging unit 26 is composed of camera elements that image ambient conditions of the traveling apparatus 10. A video (image) imaged by the imaging unit 26 is temporarily stored in the storage unit 24 and is then communicated via the communication unit 25 among the traveling apparatuses 10 or through the network 15 to the server 16. Furthermore, information on the imageable region around the imaging unit 26, which is used for control by the server 16 over the inter-vehicle distance between the traveling apparatuses 10 as well, is transmitted in real time to the server 16, together with information on the brightness acquired from the brightness sensor of the sensor unit 210.

The traveling control unit 21 is a central processing unit (CPU) and controls the units for performance of traveling operation.

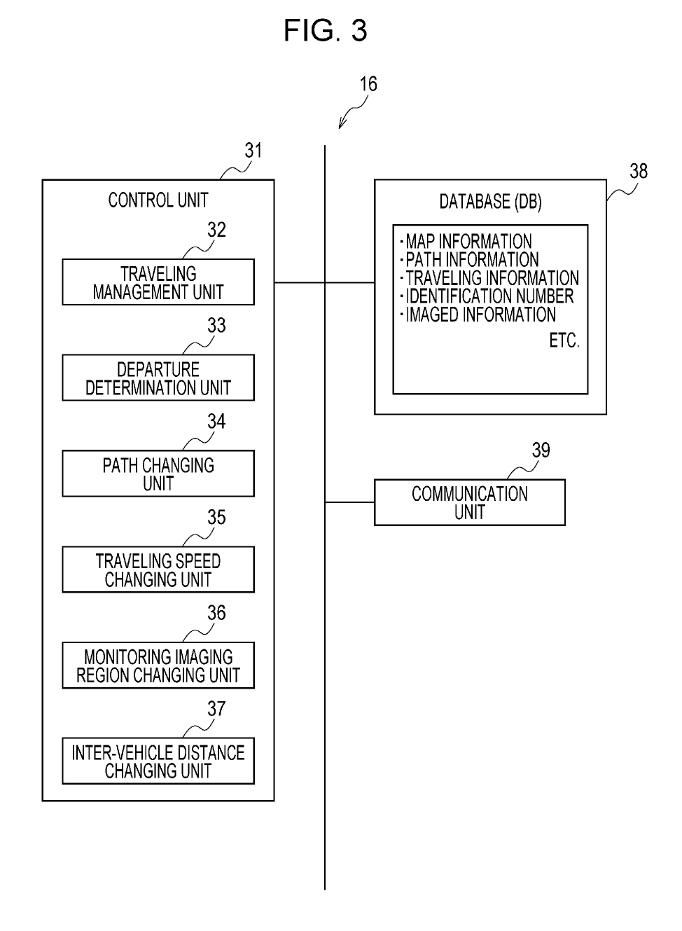

FIG. 3 is a block diagram illustrating the server.

The server 16 fulfils roles of managing the traveling of each of the traveling apparatuses 10 and giving a path change instruction to the traveling apparatus 10. The server 16 includes a control unit 31, a database (DB) 38, and a communication unit 39.

The control unit 31 is a central processing unit (CPU) and includes a traveling management unit 32, a departure determination unit 33, a path changing unit 34, a traveling speed changing unit 35, a monitoring imaging region changing unit 36, and an inter-vehicle distance changing unit 37.

The traveling management unit 32 manages the circulation traveling of each of the traveling apparatuses 10. The circulation path for each traveling apparatus 10 has been set in advance and information on the circulation path has been stored as map information or path information in the DB 38. From the traveling apparatuses 10, traveling information on the traveling status is periodically transmitted via the network 15. By the traveling management unit 32 in the control unit 31 of the server 16, the traveling information is received through the communication unit 39, stored in the DB 38, and managed.

The departure determination unit 33 determines whether a departure operation in which a traveling apparatus 10 is made to depart for the departure site 17 or the like is demanded or not based on the traveling information transmitted from the traveling apparatus 10.

The path changing unit 34 functions so as to change traveling conditions of the traveling apparatuses 10 and makes a determination to change the monitoring circulation path 11 of each of the traveling apparatuses 10 that has been set currently.

The traveling speed changing unit 35 functions so as to change the traveling conditions of the traveling apparatuses 10 and makes a determination to change a traveling speed of each of the traveling apparatuses 10 that has been set currently.

The monitoring imaging region changing unit 36 functions so as to change monitoring regions as traveling conditions of the traveling apparatuses 10 and makes a determination to change an imaging mode of each of the traveling apparatuses 10 that has been set currently.

The inter-vehicle distance changing unit 37 functions so as to change the traveling conditions of the traveling apparatuses 10 and makes a determination to change the inter-vehicle distance for each of the traveling apparatuses 10 that has been set currently.

The DB 38 is made of a mass-storage medium (such as an HDD) and stores information demanded for the circulation traveling, such as the map information, the path information on the paths for the traveling apparatuses 10, the traveling information on the current traveling status of the traveling apparatuses 10, identification numbers for identification of the traveling apparatuses 10, and the imaged videos (images) transmitted from the traveling apparatuses 10.

The communication unit 39 communicates with the traveling apparatuses 10 via the access point 14 and the network 15.

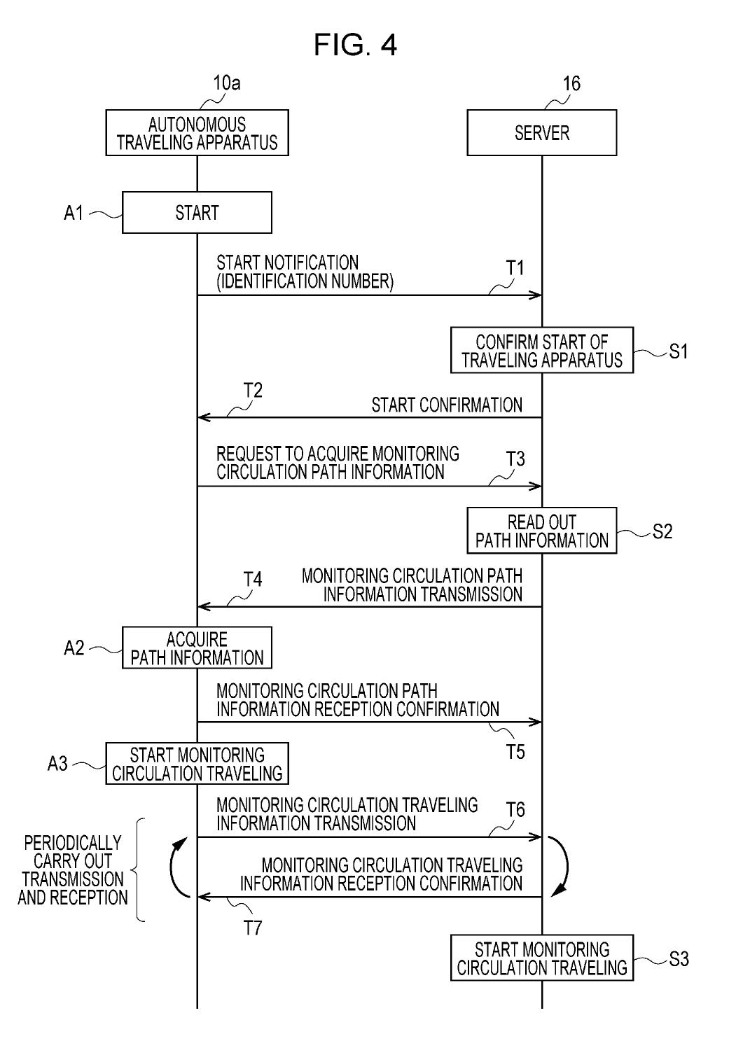

FIG. 4 is a sequence diagram illustrating processing for the circulation traveling in the traveling apparatus and the server.

Though description will be given below on the traveling apparatus 10a and the server 16, the same processing is carried out for other traveling apparatuses as well.

Upon a start of the traveling apparatus 10a (A1), the traveling control unit 21 of the traveling apparatus 10 transmits start notification that the traveling apparatus has been started, as well as the identification number of the traveling apparatus, from the communication unit 25 to the server 16 (T1).

The server 16 receives the identification number via the communication unit 39. The traveling management unit 32 of the server 16 recognizes the traveling apparatus 10a based on the identification number (S1). The communication unit 39 transmits a start confirmation signal to the traveling apparatus 10a (T2).

Description on the communication units 25 and 39 in subsequent interchange of signals is omitted.

The traveling apparatus 10a transmits a request to acquire the path information, along with the identification number, to the server 16 (T3).

The traveling management unit 32 of the server 16 reads out the path information on the traveling apparatus 10a from the DB 38 based on the identification number (S2). The monitoring circulation path information that has been read out is transmitted to the traveling apparatus 10a (T4).

The traveling control unit 21 of the traveling apparatus 10a acquires the monitoring circulation path information, stores the path information in the storage unit 24 (A2), and gives the server 16 notification of reception confirmation of the path information (T5). Then the traveling control unit 21 of the traveling apparatus 10a starts the circulation traveling along the monitoring circulation path 11 (A3).

The traveling control unit 21 of the traveling apparatus 10a transmits the traveling information to the server 16 (T6). The traveling information is information on the traveling status, such as the position information acquired by the GPS reception unit 29, information on the traveling status and the obstacles detected by the sensor unit 210, information on the battery charge detected by the battery charge detection unit 23, video (image) information imaged by the imaging unit 26, and the brightness information in the vicinity of the traveling apparatus 10.

The traveling management unit 32 of the server 16 gives the traveling apparatus 10a notification of reception confirmation of the traveling information (T7). The traveling management unit 32 of the server 16 then acquires the traveling information and stores the traveling information in the DB 38 and the control unit 31 of the server 16 makes various determinations as an occasion demands (S3). Specifically, the departure determination unit 33 determines whether the departure operation is demanded or not in relation to the battery charge, a failure in the traveling function, or a failure in the communication function, based on the traveling information. The path changing unit 34 determines whether a change in the current monitoring circulation path 11 for the traveling is demanded or not based on the traveling information. The traveling speed changing unit 35 determines whether a change in the current traveling speed is demanded or not based on the traveling information. The monitoring imaging region changing unit 36 determines whether a change in the imaging mode that is currently set is demanded or not based on the traveling information. The inter-vehicle distance changing unit 37 determines whether a change in the inter-vehicle distance between the traveling apparatuses 10 that is currently set is demanded or not. During the traveling along the monitoring circulation path 11, transmission and reception of information between the traveling apparatus 10a and the server 16 are iterated periodically.

Subsequently, determination processing in the departure determination unit 33 and processing for changing monitoring circulation traveling conditions of other traveling apparatuses that is involved by the departure operation of the traveling apparatus 10 will be described below in detail.

The first embodiment has a configuration in which, upon decrease in the battery charge in the monitoring circulation traveling of the traveling apparatus 10a in the vicinity of the monitored building 13, the traveling apparatus 10a departs from the monitoring circulation path 11 toward the departure site 17 that is the charging station, based on the instruction from the server 16, and in which the monitoring circulation traveling is carried out with a change in the monitoring circulation traveling conditions of the other traveling apparatuses such that the monitoring imaging region of the traveling apparatus 10a may be complemented by other traveling apparatuses that travel in front and rear of the traveling apparatus 10a.

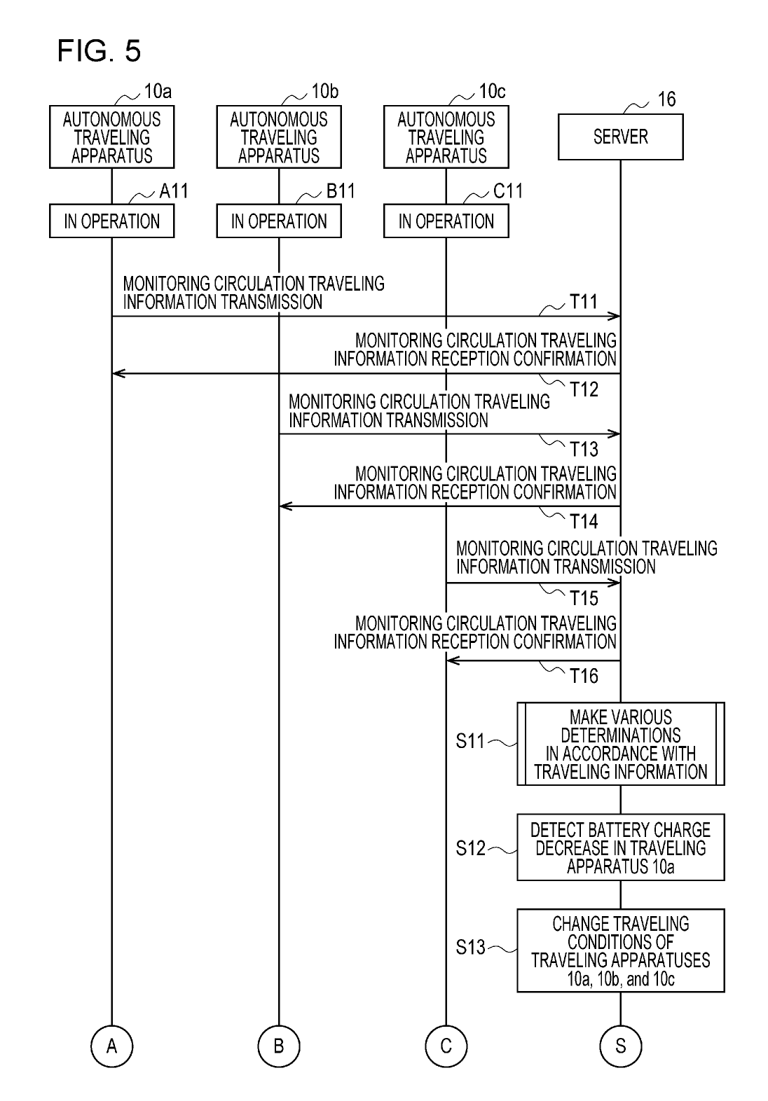

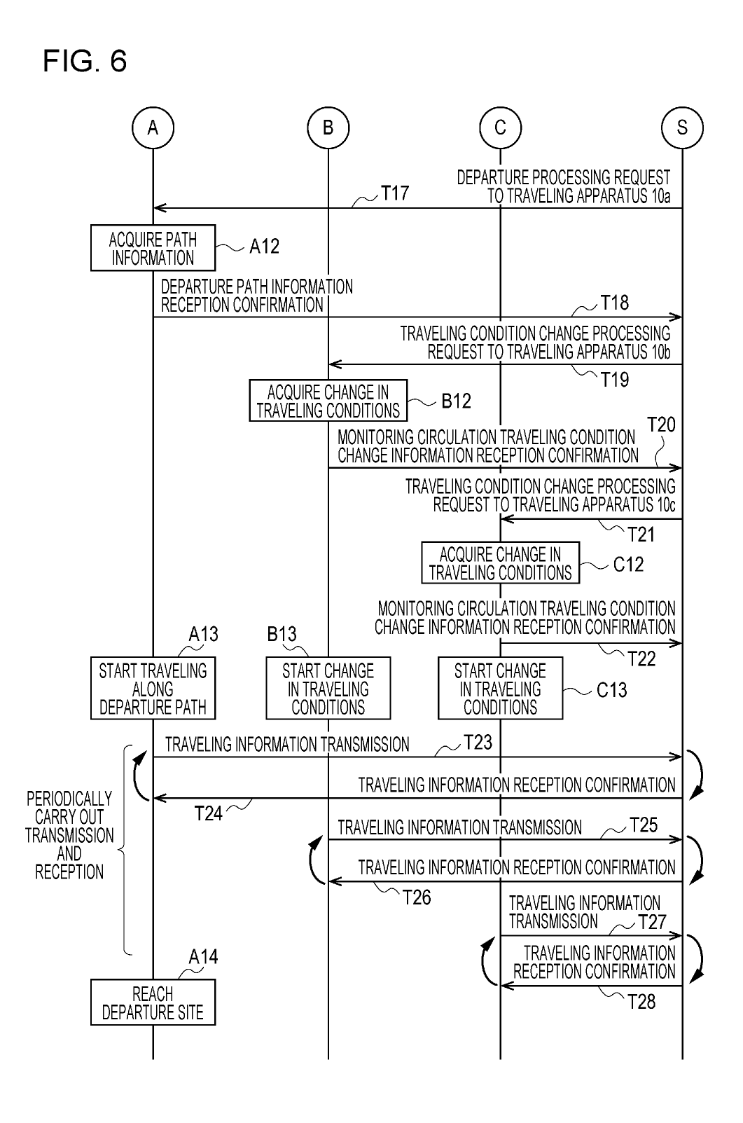

FIG. 5 is a sequence diagram illustrating the processing for changing the monitoring circulation traveling conditions in the traveling apparatuses and the server in the first embodiment. FIG. 6 is a sequence diagram following FIG. 5 and illustrating the processing for changing the monitoring circulation traveling conditions in the traveling apparatuses and the server.

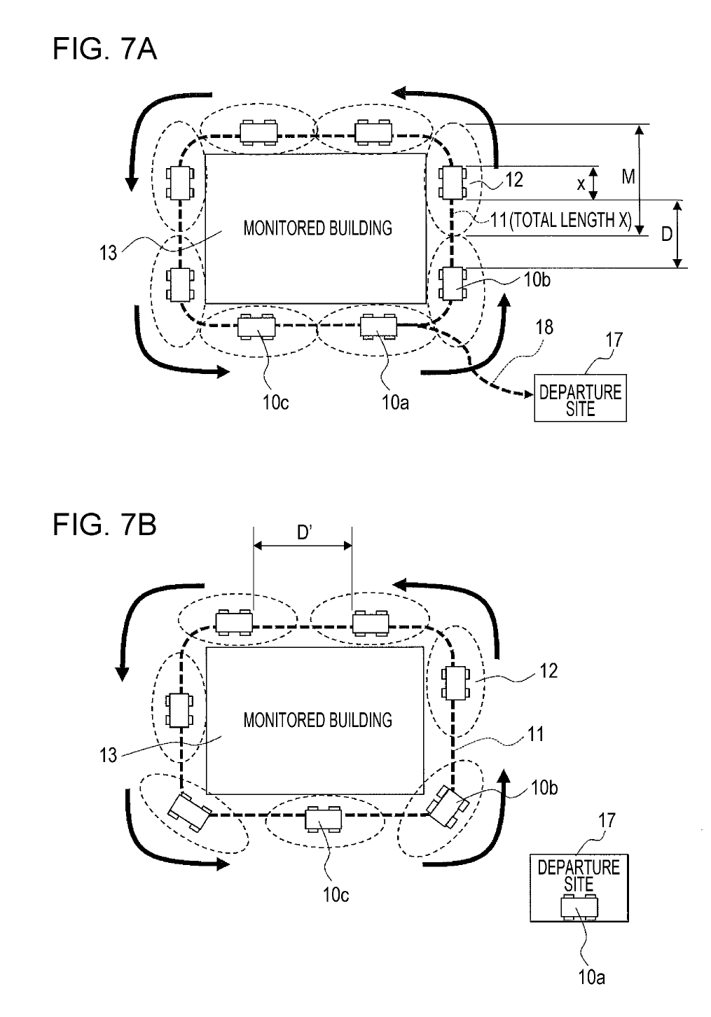

It is assumed that the traveling apparatus 10a is traveling for the monitoring circulation and that the traveling apparatus 10b and the traveling apparatus 10c travel in the front and the rear of the traveling apparatus 10a (see FIG. 7A).

As illustrated in FIG. 5, the traveling apparatuses 10a, 10b, and 10c are all traveling (A11, B11, C11). The traveling apparatuses 10a, 10b, and 10c transmit the traveling information to the server 16 (T11, T13, T15) and the server 16 gives the traveling apparatuses 10a, 10b, and 10c the notification of the reception confirmation of the traveling information (T12, T14, T16). This communication is carried out periodically at uniform intervals.

The traveling management unit 32 of the server 16 acquires the traveling information and stores the traveling information in the DB 38 and the departure determination unit 33 of the server 16 determines whether the departure operation is demanded or not based on the traveling information from the traveling apparatus 10a (S11). The departure determination unit 33 determines that the battery charge in the traveling apparatus 10a is equal to or lower than the reference value and that charging at the departure site (charging station) 17 is demanded (S12). The path changing unit 34 of the server 16 changes the monitoring circulation path 11 of the traveling apparatus 10a into the departure path 18 to the departure site 17 and changes the traveling conditions of the traveling apparatuses 10b and 10c that include the monitoring circulation paths 11 (S13).

A step (S11) of making various determinations based on the traveling information from each of the traveling apparatuses will be described.

For the first embodiment, the determination as to whether the battery charge in the traveling apparatus 10a is equal to or lower than the reference value or not has been described. As a condition for the departure from the monitoring circulation path, difficulty in the monitoring circulation traveling due to occurrence of a failure in the traveling function or the communication function may be assumed other than the battery charge that is equal to or lower than the reference value and there is no limitation to contents described for the first embodiment.

As illustrated in FIG. 6, the server 16 sends the traveling apparatus 10a a request to change a traveling path (T17). Specifically, the request to change the traveling path from the monitoring circulation path 11 into the departure path 18 toward the departure site 17 is sent.

The traveling control unit 21 of the traveling apparatus 10a carries out overwriting on the path information in the storage unit 24 (A12). The traveling control unit 21 of the traveling apparatus 10a then returns a path change response stating that the path has been changed to the server 16 (T18).

The server 16 sends the traveling apparatuses 10b and 10c requests to change the monitoring circulation traveling conditions (T19, T21).

The traveling control units 21 of the traveling apparatuses 10b and 10c each carry out overwriting on the traveling information in the storage unit 24 (B12, C12). The traveling control units 21 of the traveling apparatuses 10b and 10c each return a change response stating that the traveling information has been changed to the server 16 (T20, T22).

Then the traveling apparatus 10a starts traveling toward the departure site 17 (A13). The traveling apparatuses 10b and 10c each start traveling in accordance with the changed traveling information (B13, C13).

The traveling apparatuses 10a, 10b, and 10c each transmit the traveling information to the server 16 (T23, T25, T27) and the server 16 gives the traveling apparatuses 10a, 10b, and 10c the notification of the reception confirmation of the traveling information (T24, T26, T28). This communication is carried out periodically at uniform intervals.

The traveling apparatus 10a reaches the departure site 17 and starts the charging (A14).

Subsequently, an example of the change in the inter-vehicle distance between the traveling apparatuses in the first embodiment will be described.

FIG. 7A is an explanatory drawing illustrating an example of equal allocation of the inter-vehicle distances between a plurality of traveling apparatuses that carry out monitoring circulation in the first embodiment and FIG. 7B is an explanatory drawing illustrating an example of equal allocation of inter-vehicle distances in case of a departure of one from the plurality of traveling apparatuses that carry out the monitoring circulation.

In the first embodiment, parameters related to a monitoring circulation system are stipulated as follows and a case is assumed in which the traveling apparatuses numbering in a carry out the monitoring circulation around and imaging of a periphery of the monitored building with a total length of X meters.

Herein, it is assumed that eight traveling apparatuses 10 travel for the monitoring circulation.

(1) Monitoring circulation path (total length): X [m]
(2) Traveling apparatus (total length): x [m]
(3) Number of traveling apparatuses: a
(4) Traveling speed of traveling apparatuses: b [m/s]
(5) Inter-vehicle distance between traveling apparatuses: D [m]
(6) Monitoring imaging region: M [m]

When one of the traveling apparatuses 10 that is traveling for the monitoring circulation departs from the monitoring circulation path in the case where the traveling apparatuses 10 have the same monitoring imaging region and travel for the monitoring circulation under a condition of the equal allocation of the inter-vehicle distances, a monitoring circulation region that is made shorthanded by a departure of the traveling apparatus 10a from the monitoring circulation path may be equally complemented by other traveling apparatuses by a change in the inter-vehicle distance between the traveling apparatuses from D=(X−a×x)/a to D′={X−(a−1)×x}/(a−1), as illustrated in FIGS. 7A and 7B.

As a matter of course, it is desirable for the inter-vehicle distance D between the traveling apparatuses to be smaller than the monitoring imaging region M, that is, to be D=(X−a×x)/a<(M−x), in terms of the entire monitoring circulation system.

Depending on the number of the traveling apparatuses on the monitoring circulation path and a number of the traveling apparatuses that depart, however, it is conceivable that the inter-vehicle distance D between the traveling apparatuses may be larger than the monitoring imaging region M, that is, that D=(X−a×x)/a>(M−x) may hold. In that case, blank periods in monitoring that are each expressed as {D−(M−x)}/b [s] occur between the traveling apparatuses.

In the first embodiment, the monitoring imaging region of the traveling apparatus that departs may be complemented by the change in the inter-vehicle distance between the traveling apparatuses and additional changes in the traveling conditions of other traveling apparatuses in the requests to change the monitoring circulation traveling conditions (T19, T21).

As an example, a case may be assumed in which following parameters are stipulated in addition to the stipulated parameters related to the monitoring circulation system and in which the traveling apparatuses numbering in a carry out the monitoring circulation around and the imaging of the periphery of the monitored building with the total length of X meters.

(7) Traveling speed of traveling apparatuses: b, b′ [m/s](b<b′)

When one of the eight traveling apparatuses traveling for the monitoring circulation departs from the monitoring circulation path, as illustrated in FIGS. 7A and 7B, the blank period in monitoring: {D−(M−x)}/b′ [s] corresponding to the monitoring imaging region of the traveling apparatus that departs may be minimized by a change in the traveling speed b [m/s] of each of the traveling apparatuses to b′ [m/s] (b<b′).

According to the first embodiment configured as described above, the control unit 31 in the server 16 as the traveling management apparatus includes the traveling management unit 32, the departure determination unit 33, the path changing unit 34, the traveling speed changing unit 35, the monitoring imaging region changing unit 36, and the inter-vehicle distance changing unit 37 and the traveling management unit 32 transmits the changed traveling conditions of the traveling apparatuses 10 from the communication unit 39 to the respective traveling apparatuses 10. In this configuration, even if the traveling apparatus 10a that has been traveling is departed from the traveling path for some cause, the monitoring traveling of the traveling apparatus 10a may be complemented by the changes in the traveling conditions of other autonomous traveling apparatuses 10b, 10c, and the like, so that a monitoring function as the entire monitoring circulation system may be continuously managed without being impaired.

### Second Embodiment

Subsequently, a second embodiment will be described.

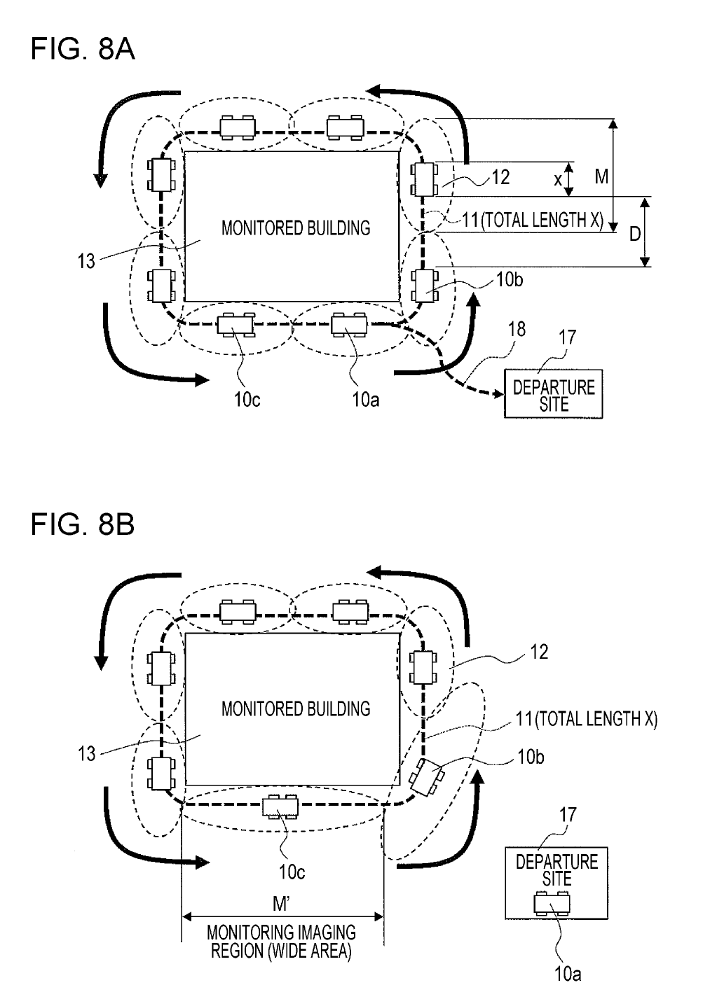

FIG. 8A is an explanatory drawing illustrating an example of equal allocation of inter-vehicle distances between a plurality of traveling apparatuses that carry out monitoring circulation in the second embodiment and FIG. 8B is an explanatory drawing illustrating an example of monitoring traveling in which the monitoring circulation is carried out with changes in the monitoring imaging regions in case of a departure of one from the plurality of traveling apparatuses that carry out the monitoring circulation.

In the second embodiment, the monitoring imaging region of the traveling apparatus that departs from the monitoring circulation path may be complemented by the changes in the inter-vehicle distances between the traveling apparatuses and additional changes in the monitoring imaging regions of the traveling apparatuses that travel in the front and the rear of the traveling apparatus that departs, in accordance with the requests to change the monitoring circulation traveling conditions (T19, T21).

As an example, a case is assumed in which a following parameter is stipulated in addition to the stipulated parameters related to the monitoring circulation system and in which the traveling apparatuses numbering in a carry out the monitoring circulation around and the imaging of the periphery of the monitored building with the total length of X meters.

(8) Monitoring imaging region: M, M′ [m] (M<M′)

When one of the eight traveling apparatuses traveling for the monitoring circulation departs from the monitoring circulation path, as illustrated in FIGS. 8A and 8B, the monitoring circulation path corresponding to the traveling apparatus that has departed may be complemented by other traveling apparatuses by continuation of the monitoring traveling with a change to the monitoring imaging region M′ (M<M′) and a change in the inter-vehicle distance between the traveling apparatuses to D′=(X−a×x)/a+M/2 as imaging conditions of the traveling apparatuses that travel in the front and the rear of the traveling apparatus which departs.

### Third Embodiment

Subsequently, a third embodiment will be described.

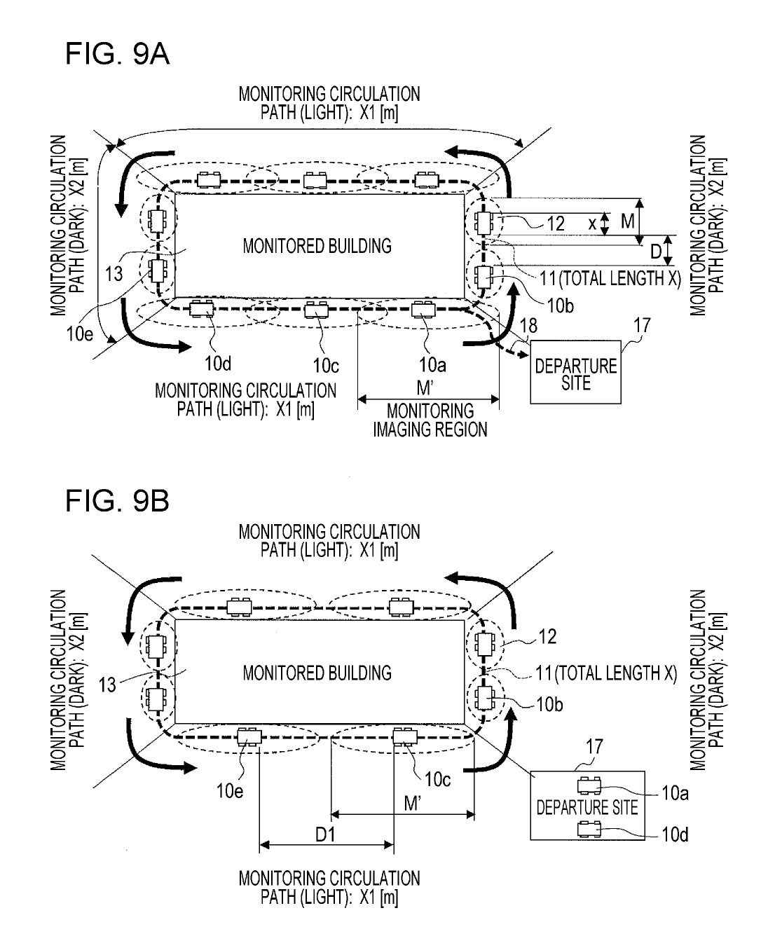

FIG. 9A is an explanatory drawing illustrating an example of equal allocation of inter-vehicle distances between a plurality of traveling apparatuses that carry out monitoring circulation in the third embodiment and FIG. 9B is an explanatory drawing illustrating an example of monitoring traveling in which the monitoring circulation is carried out in accordance with brightness on a traveling path in case of departures of two from the plurality of traveling apparatuses that carry out the monitoring circulation.

In the third embodiment, the monitoring imaging regions of the traveling apparatuses that depart may be complemented by the change in the inter-vehicle distance between the traveling apparatuses and additional dynamic switching of the monitoring imaging region of each of the traveling apparatuses based on light-dark information on the monitoring circulation path in accordance with the requests to change the monitoring circulation traveling conditions (T19, T21).

As an example, a case is assumed in which following parameters are stipulated in addition to the stipulated parameters related to the monitoring circulation system and in which the traveling apparatuses numbering in a carry out the monitoring circulation around and the imaging of the periphery of the monitored building with the total length of X meters.

### (Region in Light Surrounding Environment)

(1) Monitoring circulation path: X1 [m]
(2) Number of traveling apparatuses that travel: a1
(3) Inter-vehicle distance between traveling apparatuses: D1 [m]

### (Region in Dark Surrounding Environment)

(1) Monitoring circulation path: X2 [m]
(2) Number of traveling apparatuses that travel: a2
(3) Inter-vehicle distance between traveling apparatuses: D2 [m], (D2<D1)

As illustrated in FIGS. 9A and 9B, a case is assumed in which two traveling apparatuses 10a and 10d among ten traveling apparatuses that are traveling for the monitoring circulation depart from the monitoring circulation path.

As for imaging conditions of the traveling apparatuses that travel in front and rear of the traveling apparatuses 10a and 10d which depart, a change to the monitoring imaging region M′ may be made during traveling in a region in a light surrounding environment and a change to the monitoring imaging region M may be made during traveling in a region in a dark surrounding environment.

That is, the traveling apparatuses 10c and 10e that travel in the front and the rear of the traveling apparatuses 10a and 10d which depart may each have the monitoring imaging region set as M when traveling in a region in a dark surrounding environment and may each have the monitoring imaging region set as M′ when traveling in a region in a light surrounding environment.

Then monitoring operation may be continued while the traveling is conducted with changes in the traveling conditions between an inter-vehicle distance D1=(X1−a1×x)/a1 for the traveling in regions in the light surrounding environment and an inter-vehicle distance D2=(X2−a2×x)/a2 for the traveling in regions in the dark surrounding environment, so that monitoring areas of the traveling apparatuses that have departed may be complemented by other traveling apparatuses.

### Fourth Embodiment

Subsequently, a fourth embodiment will be described.

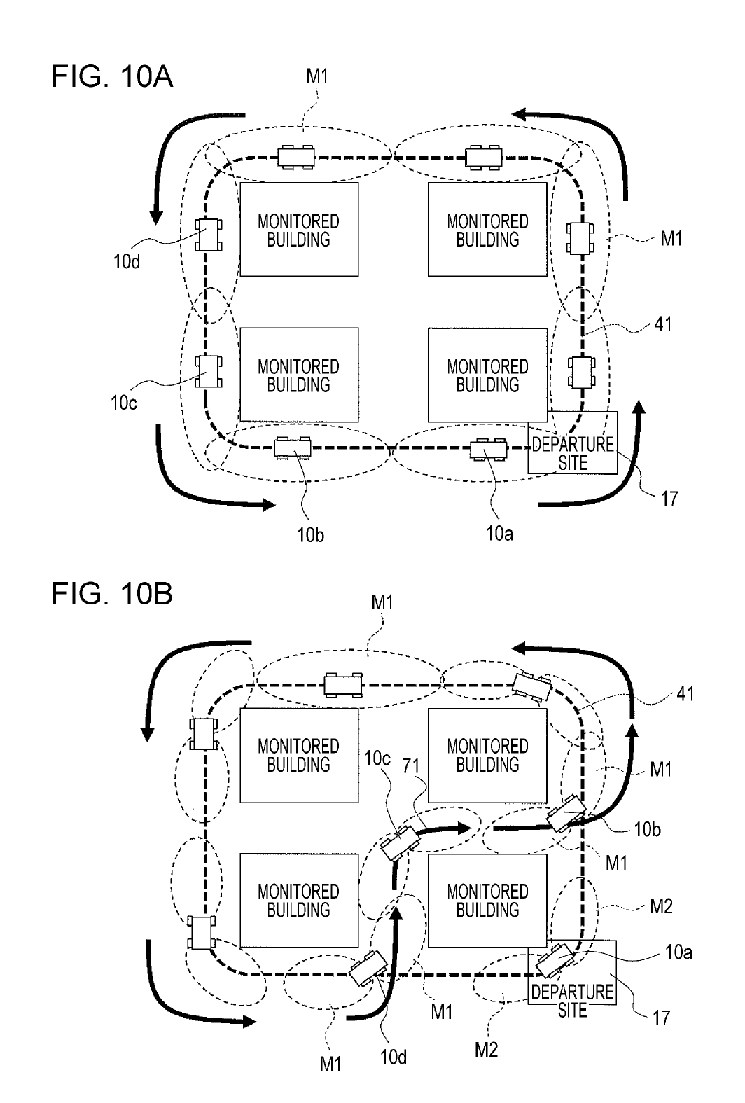

FIG. 10A is an explanatory drawing illustrating an example of equal allocation of inter-vehicle distances between a plurality of traveling apparatuses that carry out monitoring circulation in the fourth embodiment and FIG. 10B is an explanatory drawing illustrating an example of a change to fixed point observation in the traveling apparatuses.

The fourth embodiment has a configuration in which, when it is made difficult for a traveling apparatus making the monitoring circulation along a monitoring circulation path to continue the monitoring traveling, the traveling apparatus having difficulty in continuing the monitoring traveling is moved to a departure site on the monitoring circulation path, based on an instruction from outside such as a server, in which the traveling apparatus is switched into a fixed point monitoring mode, and in which monitoring circulation traveling is thereafter carried out with changes in the monitoring circulation traveling conditions of other traveling apparatuses such that a monitoring imaging region of the traveling apparatus may be complemented by other traveling apparatuses that travel in front and rear of the traveling apparatus.

Hereinbelow, processing for changing the monitoring circulation traveling conditions of the traveling apparatuses in the fourth embodiment will be described. Basically, flow of the processing for changing the monitoring circulation of the traveling apparatuses in the fourth embodiment conforms to flow illustrated in FIGS. 5 and 6 described above.

In the fourth embodiment, as illustrated in FIGS. 10A and 10B, it is assumed that the departure site 17 to which the traveling apparatus 10a departs from a monitoring circulation path 41 is located on the monitoring circulation path 41.

In case where an accidental failure makes it difficult for the traveling apparatus 10a to continue traveling along the monitoring circulation path and where the traveling apparatus 10a departs to the departure site 17 on the monitoring circulation path 41, monitoring imaging conditions may be changed so that the traveling apparatus 10a carries out fixed point monitoring imaging at the departure site 17 unless a monitoring function of the traveling apparatus 10a and the communication function of the same with the server are impaired.

Then other traveling apparatuses 10b, 10c, and 10d that travel in the front and the rear of the traveling apparatus 10a may travel for the monitoring circulation with switching to a monitoring circulation path 71 that makes a detour around the monitoring imaging region subjected to the fixed point observation by the traveling apparatus 10a. Reference characters M1 in the drawing denote monitoring imaging regions for the traveling apparatuses capable of traveling and reference characters M2 in the drawing denote a fixed point monitoring imaging region for the traveling apparatus 10a incapable of traveling.

According to the fourth embodiment configured as described above, provided that the departure site 17 to which the traveling apparatus 10a made incapable of traveling departs from the monitoring traveling is located on the monitoring circulation path 41, the traveling apparatus 10a may carry out the fixed point monitoring imaging by being turned into a fixed point, so that the other traveling apparatuses may efficiently travel for monitoring of regions except the monitoring region M2 of the traveling apparatus 10a.

### Fifth Embodiment

Subsequently, a fifth embodiment will be described.

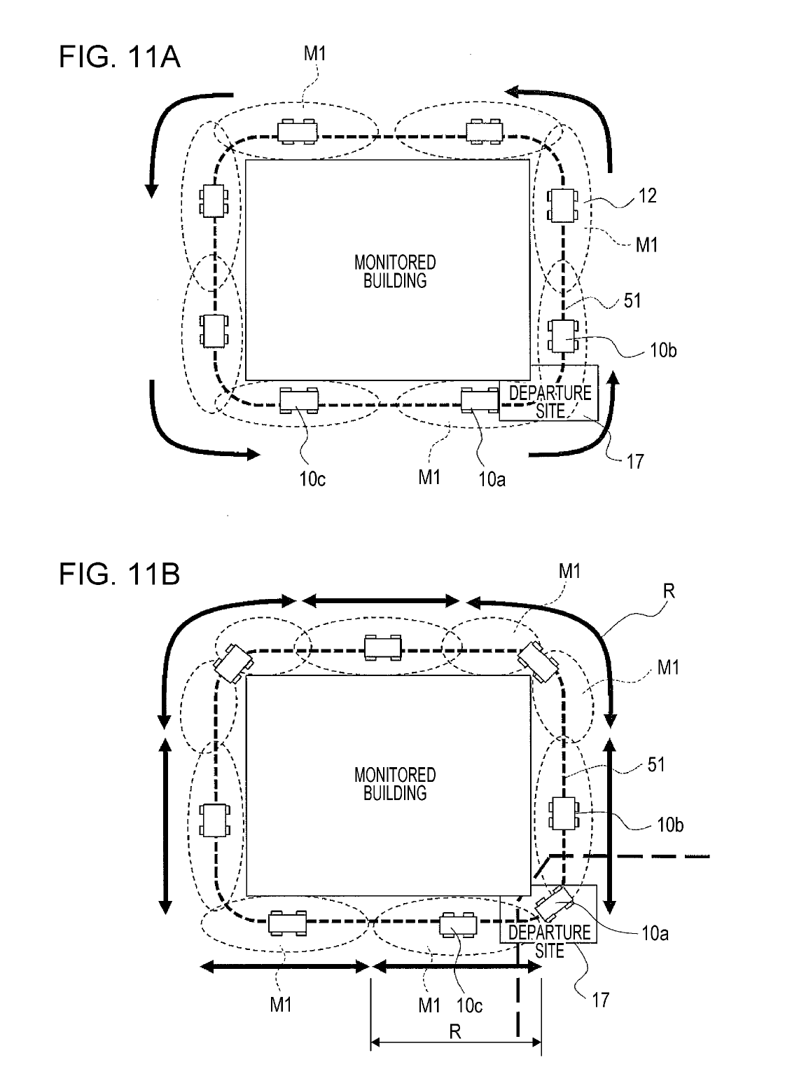

FIG. 11A is an explanatory drawing illustrating an example of equal allocation of inter-vehicle distances between a plurality of traveling apparatuses that carry out monitoring circulation in the fifth embodiment and FIG. 11B is an explanatory drawing illustrating an example of monitoring traveling with reciprocation traveling of the traveling apparatuses.

The fifth embodiment has a configuration in which, when it is made difficult for a traveling apparatus making monitoring circulation along a monitoring circulation path to continue traveling for monitoring, the traveling apparatus having difficulty in continuing the traveling for monitoring is moved to and stopped at a departure site on the monitoring circulation path, based on an instruction from outside such as a server, and in which monitoring circulation traveling is thereafter carried out with changes in the monitoring circulation traveling conditions such that the other traveling apparatuses may reciprocate along specified paths in order to complement a monitoring imaging region of the traveling apparatus.

Hereinbelow, processing for changing the monitoring circulation traveling conditions of the traveling apparatuses in the fifth embodiment will be described. Basically, flow of the processing for changing the monitoring circulation of the traveling apparatuses in the fifth embodiment conforms to the flow illustrated in FIGS. 5 and 6 described above.

In the fifth embodiment, as illustrated in FIGS. 11A and 11B, it is assumed that it is made difficult for the traveling apparatus 10a to continue traveling along a monitoring circulation path 51 and that the traveling apparatus 10a departs to the departure site 17 on the monitoring circulation path 51.

In case where an accidental failure makes the traveling apparatus 10a continue to stop at the departure site 17, the traveling apparatus 10a blocks the monitoring circulation path 51 and thereby blocks the following traveling apparatus 10c from traveling on the monitoring circulation path 51.

When the server 16 detects that the traveling apparatus 10a stops at the departure site 17, from the traveling information from the traveling apparatus 10a, the server 16 may change the traveling conditions of each of other traveling apparatuses 10b, 10c, and the like so as to effect switching to reciprocation traveling that centers at a detection position of the failure in the traveling apparatus 10a and may continue the monitoring of the vicinities of the traveling apparatuses.

In the fifth embodiment, as illustrated in FIG. 11B, the monitoring traveling with the reciprocation traveling of the other traveling apparatuses 10b, 10c, and the like may be carried out as the reciprocation traveling in ranges each having a reciprocation traveling distance R [m] that is substantially equivalent to the monitoring region M1.

According to the fifth embodiment configured as described above, even though a traveling apparatus stranded in the monitoring circulation path 51 blocks the other traveling apparatuses from traveling with the circulation, the monitoring traveling in the preset monitoring circulation path 51 may be carried out with the reciprocation traveling of each of the traveling apparatuses capable of traveling in the travelable range on the monitoring circulation path 51.

The monitoring traveling with the reciprocation of the traveling apparatuses capable of traveling is not limited to the above and may include reciprocation traveling in ranges preset in accordance with a number of traveling apparatuses that stop, for example, or reciprocation traveling in which a distance monitorable by each of the traveling apparatuses is set by calculation of a monitoring imaging distance, for instance.

Programs that run in the traveling apparatuses (autonomous traveling apparatuses) or the traveling management apparatus of the disclosure may be programs that each control a central processing unit (CPU) or the like (programs that each make a computer function) so as to attain functions of the above-described embodiments related to the disclosure. Information that is handled in the apparatuses is temporarily stored in a random access memory (RAM) when being processed, is thereafter stored in a read only memory (ROM) such as a flash ROM or a hard disk drive (HDD), and undergoes readout, modification, or writing by a CPU as occasion demands. Programs for attaining functions of each configuration may be recorded in a machine readable recording medium and processing in the units may be carried out by reading the programs, recorded in the recording medium, into a computer system and executing the programs. Herein, the “computer system” includes OS and hardware such as peripherals.

The term “machine readable recording medium” refers to a portable medium (non-transitory computer-readable medium) such as a flexible disk, a magneto-optical disk, a ROM, and a CD-ROM or a storage device such as an internal hard disk in a computer system. The above programs may be intended for attaining some of the functions described above or may be capable of attaining the functions described above by being combined with programs recorded in a computer system.

Though the traveling management for the plurality of traveling apparatuses 10 is exercised by the external server 16 that functions as the traveling management apparatus, in the embodiments described above, the traveling management for the traveling apparatuses 10 is not limited thereto. For instance, each of the traveling apparatuses 10 may be equipped with a traveling management apparatus that manages the traveling and the traveling apparatuses 10 in cooperation with one another may travel for the monitoring while managing the traveling status without the traveling management by the server 16.

Though the embodiments of the disclosure have been described above in detail with reference to the drawings, specific configurations thereof are not limited to the embodiments and encompass technology modified in design or the like within a scope not departing from the purport of the disclosure.

The present disclosure contains subject matter related to that disclosed in Japanese Priority Patent Application JP 2017-059587 filed in the Japan Patent Office on Mar. 24, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A traveling management apparatus for autonomous traveling apparatuses that exercises traveling management of a plurality of autonomous traveling apparatuses which autonomously travel based on preset path information, the traveling management based on traveling information indicating traveling status as notification from the autonomous traveling apparatuses, the traveling management apparatus comprising:
a communication unit that communicates with the autonomous traveling apparatuses;
a departure determination unit that determines whether a departure from monitoring circulation along a preset traveling path is to be made or not based on the traveling information on a relevant autonomous traveling apparatus;
a traveling condition changing unit that, when the departure determination unit determines that the relevant autonomous traveling apparatus is to depart from the monitoring circulation, changes traveling conditions for monitoring traveling of the other autonomous traveling apparatuses so that a monitoring region based on the path information on the autonomous traveling apparatus which is to depart from the monitoring circulation is complemented; and
a traveling management unit that manages traveling of the autonomous traveling apparatuses,
wherein the traveling management unit transmits the changed traveling conditions from the communication unit to the respective autonomous traveling apparatuses.

2. The traveling management apparatus according to claim 1, wherein the traveling conditions that are changed by the traveling condition changing unit are traveling speeds of the other autonomous traveling apparatuses.

3. The traveling management apparatus according to claim 1, wherein the traveling conditions that are changed by the traveling condition changing unit are inter-vehicle distances between the other autonomous traveling apparatuses.

4. The traveling management apparatus according to claim 1, wherein the traveling conditions that are changed by the traveling condition changing unit include imaging conditions, during the monitoring traveling, of imaging devices provided in the other autonomous traveling apparatuses.

5. The traveling management apparatus according to claim 1, wherein the traveling conditions that are changed by the traveling condition changing unit are traveling speeds of the other autonomous traveling apparatuses, during the monitoring traveling, based on light-dark information in vicinities of the other autonomous traveling apparatuses that are traveling.

6. The traveling management apparatus according to claim 1, wherein the traveling condition changing unit equally allocates inter-vehicle distances between the other autonomous traveling apparatuses based on the traveling conditions acquired from the other autonomous traveling apparatuses in order to complement a monitoring region of the autonomous traveling apparatus that departs from the preset traveling path.

7. The traveling management apparatus according to claim 1, wherein the traveling condition changing unit changes and increases traveling speeds of the other autonomous traveling apparatuses based on the traveling conditions acquired from the other autonomous traveling apparatuses in order to complement a monitoring region of the autonomous traveling apparatus that departs from the preset traveling path.

8. The traveling management apparatus according to claim 1, wherein the traveling condition changing unit changes and increases monitorable regions of the other autonomous traveling apparatuses based on the traveling conditions acquired from the other autonomous traveling apparatuses in order to complement a monitoring region of the autonomous traveling apparatus that departs from the preset traveling path.

9. The traveling management apparatus according to claim 1, wherein the traveling condition changing unit allocates inter-vehicle distances between the autonomous traveling apparatuses with specified weighting based on vicinal light-dark information in the traveling conditions acquired from the other autonomous traveling apparatuses in order to complement a monitoring region of the autonomous traveling apparatus that departs from the preset traveling path.

10. The traveling management apparatus according to claim 1, wherein the traveling condition changing unit allocates inter-vehicle distances between the other autonomous traveling apparatuses with specified weighting based on map information or video information on vicinities of the other autonomous traveling apparatuses in order to complement a monitoring region of the autonomous traveling apparatus that departs from the preset traveling path.

11. The traveling management apparatus according to claim 1, wherein the traveling condition changing unit allocates monitoring regions to the other autonomous traveling apparatuses with specified weighting based on map information or video information on vicinities of the other autonomous traveling apparatuses in order to complement a monitoring region of the autonomous traveling apparatus that departs from the preset traveling path.

12. The traveling management apparatus according to claim 1, wherein, when the departure determination unit determines that the departure operation is demanded based on the traveling information, the autonomous traveling apparatus is moved to a departure site and subsequently makes fixed point observation at the departure site.

13. The traveling management apparatus according to claim 12, wherein, while the autonomous traveling apparatus makes the fixed point observation at the departure site, the traveling condition changing unit excludes a monitoring region subjected to the fixed point observation at the departure site from the traveling path for the other autonomous traveling apparatuses.

14. The traveling management apparatus according to claim 12, wherein, on condition that the departure site is located on the traveling path, the traveling path for each of the other autonomous traveling apparatuses is made into a traveling path for which traveling with circulation around the specified path is switched into reciprocation traveling, except for a monitoring region subjected to the fixed point observation at the departure site.

15. An autonomous traveling apparatus having a traveling management apparatus that exercises traveling management of a plurality of autonomous traveling apparatuses which autonomously travel based on preset path information, the traveling management based on traveling information indicating traveling status as notification from the autonomous traveling apparatuses, the autonomous traveling apparatus comprising:
the traveling management apparatus according to claim 1, as the traveling management apparatus.

16. A traveling management method for autonomous traveling apparatuses of exercising traveling management of a plurality of autonomous traveling apparatuses which autonomously travel based on preset path information, the traveling management based on traveling information indicating traveling status as notification from the autonomous traveling apparatuses, the traveling management method comprising:
communicating with the autonomous traveling apparatuses;
determining whether a departure from monitoring circulation along a preset traveling path is to be made or not based on the traveling information on a relevant autonomous traveling apparatus;
changing traveling conditions for monitoring traveling of the other autonomous traveling apparatuses, when a determination is made in the determining that the relevant autonomous traveling apparatus is to depart from the monitoring circulation, so that a monitoring region based on the path information on the autonomous traveling apparatus which is to depart from the monitoring circulation is complemented; and
managing traveling of the autonomous traveling apparatuses,
wherein the managing includes transmitting the changed traveling conditions through the communicating to the respective autonomous traveling apparatuses.

17. A non-transitory computer-readable medium storing a traveling management program for autonomous traveling apparatuses that exercises traveling management of a plurality of autonomous traveling apparatuses which autonomously travel based on preset path information, the traveling management based on traveling information indicating traveling status as notification from the autonomous traveling apparatuses, the traveling management program making a computer execute a process comprising:
communicating with the autonomous traveling apparatuses;
determining whether a departure from monitoring circulation along a preset traveling path is to be made or not based on the traveling information on a relevant autonomous traveling apparatus;
changing traveling conditions for monitoring traveling of the other autonomous traveling apparatuses, when a determination is made in the determining that the relevant autonomous traveling apparatus is to depart from the monitoring circulation, so that a monitoring region based on the path information on the autonomous traveling apparatus which is to depart from the monitoring circulation is complemented;
managing traveling of the autonomous traveling apparatuses; and
transmitting the changed traveling conditions through the communicating to the respective autonomous traveling apparatuses in the managing.
